(19) United States
(12) Patent Application Publication
(10) Pub. No.: US 2006/0257292 A1
(43) Pub. Date: Nov. 16, 2006

(54) Pipette tip tray for dispensing partial rows of tips

(76) Inventor: Arta Motadel, La Jolla, CA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/128,118

(22) Filed: May 12, 2005

(51) Int. Cl. B01L 9/00

(52) U.S. Cl. 422/104

(57) ABSTRACT

A tray for holding pipette tips to permit an associated pipettor head to be positioned to pick up less than one full row or less than one full column of tips from the tray includes recessed corner portions in the tray surface to provide clearance for a descending nozzle positioned outside linear alignment with a row or a column.

### BACKGROUND OF THE INVENTION

The present invention pertains to a tray for holding an array of pipette tips for automated pickup by a multi-nozzle head of a pipettor apparatus. More particularly, the invention is directed to a tray construction adapted to accommodate unused nozzles when less than one row or less than one column of tips is dispensed from the tray.

In biochemical, pharmaceutical and clinical testing, pipetting apparatus is used to transfer small volumes of reagents and samples for various types of testing and assay procedures. Pipette tips are conventionally furnished for use in tip holders which carry a rectilinear array of tips in equally spaced rows and columns, for example, an 8×12 array of 96 pipette tips. The tip holder typically includes a tray having a planar upper surface provided with a pattern of columns and rows of circular openings for receipt and support of the pipette tip array. The pipette tips are supported somewhat loosely in the tray surface so they may be easily picked up by the nozzles of a pipettor head which is automatically controlled to move laterally over the tray and vertically downward to cause the nozzles to enter the upper mounting collars of the pipette tips.

The pipette tip holder also typically includes an enclosing box having a removable cover. The tip holding tray, carrying an array of tips, generally lies over the top of the box with the lower tapered tip ends extending downwardly into the box with all or a portion of the upper tip barrels extending upwardly from the supporting surface and enclosed by a lid. This typical packaging protects the tips from damage and contamination.

In one commonly used type of tip holding tray, the openings in the tray surface are provided with shoulders for supporting the pipette tip collars which shoulders are vertically recessed below the tray surface. The pipette tip barrels enter at least partially into the openings where the barrels change throughout engage and are supported by the shoulders. When a pipettor head, containing for example an 8×12, array of nozzles is lowered to insert the nozzles into the pipette tip collars, the nozzles also enter the openings for at least a short distance below the planar upper surface of the tray. It is sometimes necessary or desirable to use less than all of the rows or less than all of the columns of pipette tips in which case the head would be programmed to pick up one or more rows or one or more columns, but not all, of the tips. It was found, however, that typical prior art tip holding trays could not accommodate this type of partial array pickup because the row or column of unused nozzles nearest the edge of the tray corresponding to the row or column, would hit the edge of the tray and prevent entry of the array of active nozzles into the openings in the tray surface.

To overcome this problem, a tray was designed with recesses in the lateral edges of the tray that correspond to the columns and rows and are sized and positioned to receive a row or a column of unused nozzles as the head and nozzles move downwardly to pick up the complete rows or complete columns of tips for the desired procedure.

However, it has recently been found useful and desirable to be able to utilize an automated pipettor head to pick up less than one row or less than one column of tips, including a single tip. If a pipettor head is programmed to pick up less than one row or less than one column of tips, the nozzle positioned at the corner of the tray (outside the array and diagonally adjacent to the end of a column or a row) will strike the corner of the tray and not permit the head to be lowered vertically to allow the nozzles to be used to enter the pipette tip collars.

### SUMMARY OF THE INVENTION

In accordance with the present invention, the corners of a pipette tip tray are recessed to permit the passage of an unused corner nozzle when less than one row or less than one column of tips is being utilized.

Thus, in a typical pipette tip holding tray for use with a vertically movable pipettor head having a rectilinear array of columns and rows of tip-receiving nozzles, the tip holding tray is provided with a planar surface having a pattern of columns and rows of circular openings for the receipt and support of pipette tips. The lateral edges of the tray surface are provided with recesses that correspond to the columns and rows and are adapted to receive a row or column of unused nozzles when less than all rows or all columns of nozzles are used. In accordance with the improvement of the present invention, the corners of the tray surface are provided with recessed portions each of which is formed adjacent and aligned with the endmost recesses of a column and a row and positioned to receive an unused nozzle, thereby permitting the pipettor head to be positioned to receive less than one row or less than one column of tips. The modified pipette tip holding tray of the present invention is particularly adapted for use with a tray in which the openings in the tray surface have tip-supporting shoulders that are recessed below the planar surface of the tray to permit the nozzles to move downward past the surface.

The recesses in the edges of the tray surface are preferably semi-cylindrical and, in the preferred embodiment, the recessed portions are also semi-cylindrical.

### BRIEF DESCRIPTION OF THE DRAWINGS

FIG. 1 is a perspective view of a pipette tip holding tray of the present invention, shown carrying one of an array of pipette tips the tray is adapted to carry.

FIG. 2 is an enlarged detail of a portion of FIG. 1.

FIG. 3 is a perspective view of the head of a pipettor apparatus showing the array of nozzles corresponding to the pipette array in. FIG. 1 and carrying a number of rows of pipette tips.

FIG. 4 is a plan view of the pipettor head shown positioned schematically over a prior art tip holding tray in a position to receive and pick up two complete rows of tips.

FIG. 5 is a view similar to FIG. 4 showing the tip holding tray of the present invention positioned with respect to the pipettor head to permit the nozzles to receive and pick up less than two complete rows of tips.

### DETAILED DESCRIPTION OF THE PREFERRED EMBODIMENT

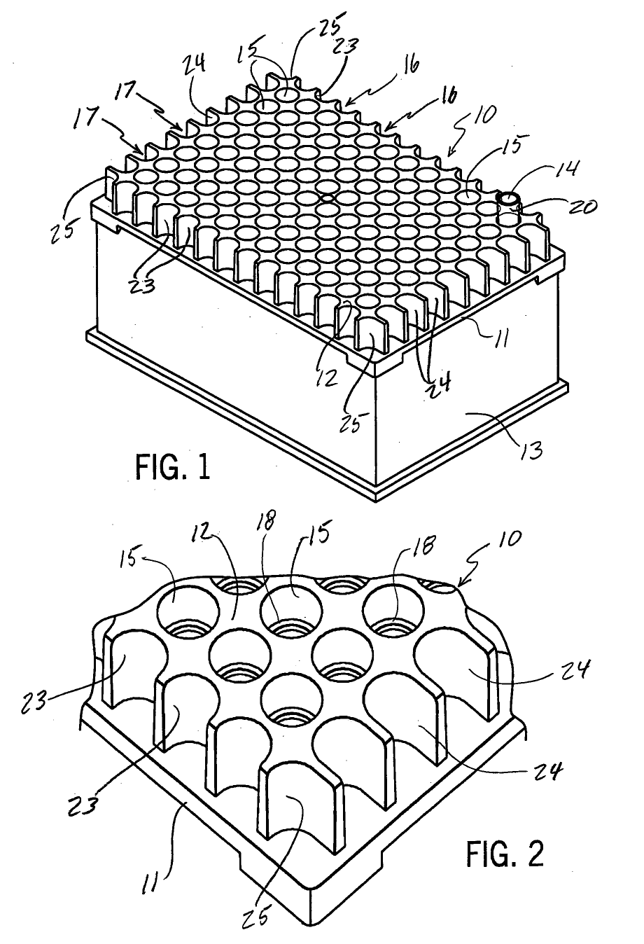

Referring initially to FIGS. 1 and 2, a pipette tip holding tray 10 includes a lower peripheral edge frame 11 and a raised planar surface 12. The edge frame 11 is adapted to be placed on and enclose a lower box 13 into which the lower ends of an array of pipette tips 14 extend. The tips 14 are supported in an array of circular openings 15 in the tray surface 12. For shipment, the box 13 and tray 10 are closed with a cover (not shown) that rests on the edge frame 11.

The openings 15 for the pipette tips 14 are arranged in a rectilinear array of 96 openings comprising twelve rows 16 and eight columns 17. A 96-tip tray is conventional, but many other types of tip trays having rectilinear arrays that are larger or smaller are utilized. The openings 15 in the surface 12 of the tray 10 are cylindrical in shape and somewhat larger in diameter than the maximum diameter of the tips 14. At the base of each cylindrical opening, there is an annular shoulder 18 having a diameter slightly smaller than the upper barrel 20 of the tip 14. The bottom end of the barrel (not shown) is provided with an annular rim that rests on the shoulder 18 to support the tip in the tray 10.

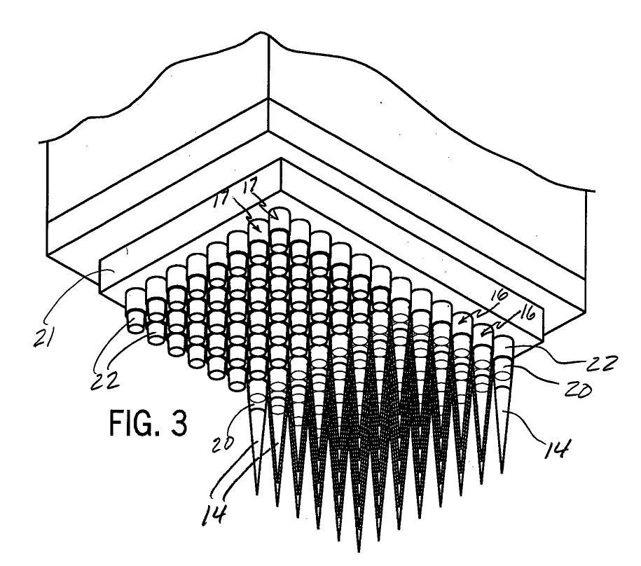

With an array of 96 tips (in the embodiment shown) supported in the tip tray 10, the tray and supporting box 13 are positioned in operative association with a pipettor apparatus, shown in FIG. 3, that includes a head 21 from which an array of 96 nozzles 22 depend downwardly. The array of nozzles 22 utilizes the same row and column arrangement, as well as spacing, of the tip tray 10 and tips 14 supported therein. The pipettor head 21, which is typically robotically controlled, is programmed to move laterally and linearly from either the side defined by the rows 16 or the side defined by the columns 17 directly over the tray 10. The head 21 is then moved vertically downward until the nozzles 22 enter the pipette tip barrels 20 until frictional engagement therewith is attained. The head 21, with the tips 12 carried by the nozzles 22, is moved vertically up and linearly away from the now empty tray 10. The head then carries the tips to an adjacent location where the lower tip ends are inserted into appropriate reagents or the like drawn into the tips by vacuum pressure applied to the nozzles from the header, all in a manner well known in the art.

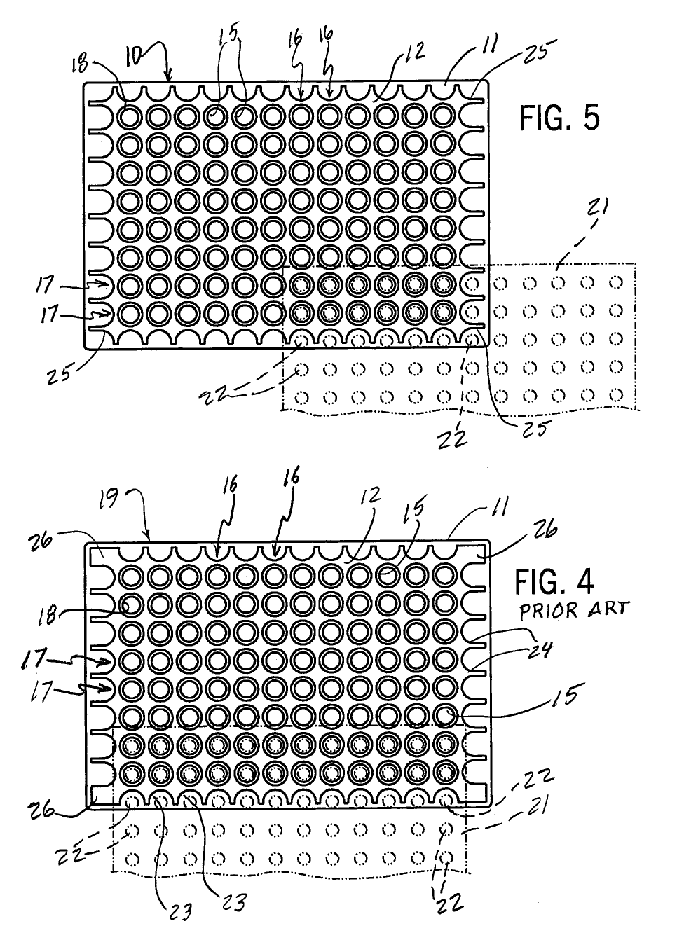

It is also known to utilize the pipettor head 21 to pick up fewer than all of the rows 16 or fewer than all of the columns 17 of tips. For example, and referring to FIG. 4, the head 21 may be positioned over a prior art tray 19 to pick up only two columns 17 comprising 24 tips by simply halting linear movement of the head in its path over the tray. If the pipettor apparatus is designed and operated to move the head linearly in the direction of the columns 17, the head may similarly be positioned to pick up less than twelve rows 16 of tips 14. To accommodate the operation of the pipettor head to pick up less than all eight columns of tips or less than all twelve rows of tips, it has been necessary to provide clearance for the column or row of unused nozzles 22 which lie laterally outside and immediately adjacent the tray 19 when less than all of the rows or columns of tips are used. As seen in FIG. 4, the tray edge frame 11 is provided with semi-circular recesses 23 on opposite ends of the rows 16 and similar deepened recesses 24 on opposite ends of the columns 17. With this arrangement and referring to FIG. 4, the first column of nozzles 22 adjacent the edgemost column of openings 15 passes vertically into the recesses 23 when the two columns of nozzles 22 that are being used move vertically downward into the openings 15 and below the planar surface 12. This arrangement could, of course, be used to pick up any number of columns less than all eight or any number of rows less than all twelve.

It is sometimes necessary or desirable to use the pipettor apparatus to accommodate only a few samples requiring the use of only a few pipette tips 14. However, with the operating process described above, the fewest number of tips that may be utilized is a single column of twelve tips or a single row of eight tips, depending upon how the tray 10 and head 21 are designed to operate. Referring to FIG. 5 and in accordance with the present invention, the surface portion 12 of the tray has been modified to permit the pipettor head 21 to be positioned to receive and pick up less than one row 16 or less than one column 17 of tips 14. If necessary, the head 21 could be utilized with the modified tip tray 10 to pick up a single tip 14. To accommodate the necessary offsetting of the head 21 in both the X and Y directions, the corners of the surface portion of the tray 10 are also provided with recessed portions 25, preferably of a generally semi-cylindrical shape. This construction replaces the solid corners 26 of the FIG. 4 tray construction. The modified tip tray 10 with the recessed corner portions 25 permits the head to be utilized to handle a wide range of rectilinear arrays of tips, such as a 4×6 arrangement of 24 tips, as well as many others including a single or several tips.

The tray edges with the rows of semi-circular recesses 16, deepened recesses 24 and recessed portions 25 define, in plan view, a scalloped appearance. However, it is not necessary that the recesses or recessed portions be formed with a semi-cylindrical shape. The recesses, as well as the recessed portions, may be square or rectangular in shape. They must simply be large enough to provide clearance for the unused nozzles 22 immediately adjacent an outer most row or column of openings 15. However, the semi-cylindrical shape of the preferred embodiment adds strength and rigidity to the tray and is preferred.

What is claimed is:

1. In a pipette tip holding tray for use with a vertically movable pipettor head having a rectilinear array of columns and rows of tip-receiving nozzles, the tray having a planar surface with a pattern of columns and rows of circular openings for the receipt and support of pipette tips, the lateral edges of the tray surface having recesses corresponding to said columns and rows to receive a row or column of unused nozzles when less than all rows or all columns of nozzles are used, the improvement comprising:
recessed portions in the corners of the tray surface, each recessed portion formed adjacent and aligned with the endmost recesses of a column and row and positioned to receive an unused nozzle, whereby the pipettor head can be positioned to receive less than one row or less than one column of tips.

2. The tip holding tray as set forth in claim 1 wherein the openings in the tray surface have shoulders below the surface that are vertically recessed for supporting the tips.

3. The tip holding tray as set forth in claim 1 wherein the recesses on the edges of the tray surface are semi-cylindrical.

4. The tip holding tray as set forth in claim 1 wherein the recessed portions are semi-cylindrical.

5. A pipette tip holding tray for use with a pipettor head having a rectilinear array of columns and rows of tip-engaging nozzles, said tray comprising:
a planar upper surface having an array of openings for the receipt and support of pipette tips, said array of openings corresponding to said array of nozzles;
the lateral outer edges of the tray surface having recesses aligned linearly with and corresponding to said columns and rows which recesses are adapted to receive a row or a column of unused nozzles when less than all rows or all columns of nozzles are used; and,
recessed portions in the corners of the tray surface positioned outside linear alignment with a column or a row of tips to receive an unused nozzle.

6. The tray as set forth in claim 5 wherein said recesses comprise rows and columns of semi-cylindrical recesses each aligned with a row or a column.

7. The tray as set forth in claim 5 wherein said recessed portions comprise semi-cylindrical recesses.
